(19) United States
(12) Patent Application Publication
(10) Pub. No.: US 2025/0292685 A1
(43) Pub. Date: Sep. 18, 2025

(54) CONTROL APPARATUS, CONTROL METHOD THEREOF, AND STORAGE MEDIUM

(71) Applicant: HONDA MOTOR CO., LTD., Tokyo (JP)

(72) Inventors: Kotaro FUJIMURA, Wako-shi (JP); Atsushi KATO, Wako-shi (JP)

(21) Appl. No.: 19/056,568

(22) Filed: Feb. 18, 2025

(30) Foreign Application Priority Data
Mar. 18, 2024 (JP) 2024-042303

(51) Int. Cl. G08G 1/16; B60W 30/09; G06V 20/56; G06V 20/58; G08G 1/0967

(52) U.S. Cl. CPC G08G 1/166; G06V 20/58; G06V 20/588; G08G 1/096725; B60W 30/09; B60W 2552/53

(57) ABSTRACT

A control apparatus recognizes a state of a target in an external environment of a moving body, recognizes lines for distinguishing a traveling lane on a movement route on which the moving body travels, and sets, on the movement route, a search area for calculating a risk that is an index value indicating a degree to which the moving body needs to avoid entry. The control apparatus calculates the risk in the search area, and determines an action of the moving body based on the calculated risk. The control apparatus sets the search area based on a first line closest to the moving body among the recognized lines for distinguishing the traveling lane.

### CROSS-REFERENCE TO RELATED APPLICATION(S)

This application claims priority to and the benefit of Japanese Patent Application No. 2024-042303, filed Mar. 18, 2024, the entire disclosure of which is incorporated herein by reference.

### BACKGROUND OF THE INVENTION

### Field of the Invention

The present invention relates to a control apparatus, a control method thereof, and a storage medium.

### Description of the Related Art

Conventionally, a driving assistance technique for assisting a driver who drives a moving body such as a vehicle has been developed. For example, as a technique for assisting driving of a driver according to a risk of another vehicle, there is known a technique for issuing a warning when there is a possibility that another vehicle changing a lane comes into contact with a self-vehicle while the self-vehicle is traveling (Japanese Patent Laid-Open No. 2018-185673).

Meanwhile, in the case of traveling on a traveling road having a plurality of traveling lanes including an overtaking lane, a right-turn lane, and the like, the content of driving assistance may vary depending on which traveling lane another vehicle is present in. For example, the content of driving assistance may be different between a case where the other vehicle is stopped ahead on a traveling lane in which the self-vehicle travels and a case where the other vehicle is stopped on a right-turn lane different from the traveling lane in which the self-vehicle travels. However, there is a case where a line (for example, a dividing line such as a white line) or the like on a road for distinguishing a traveling lane is faded and thus unclear, and it is difficult to distinguish the traveling lane and perform appropriate driving assistance when a vehicle cannot correctly recognize the dividing line.

### SUMMARY OF THE INVENTION

The present invention has been made in view of the above problem, and an object thereof is to realize a technique capable of appropriately assisting driving even when some lines among a plurality of lines for distinguishing a traveling lane cannot be recognized.

In order to solve the aforementioned issues, one aspect of the present disclosure provides a control apparatus comprising: one or more processors; and a memory storing instructions which, when the instructions are executed by the one or more processors, cause the control apparatus to function as: a target recognition unit configured to recognize a state of a target in an external environment of a moving body; a line recognition unit configured to recognize lines for distinguishing a traveling lane on a movement route on which the moving body travels; a setting unit configured to set, on the movement route, a search area for calculating a risk that is an index value indicating a degree to which the moving body needs to avoid entry; a calculation unit configured to calculate the risk in the search area; and a determination unit configured to determine an action of the moving body based on the calculated risk, wherein the setting unit sets the search area based on a first line closest to the moving body among the recognized lines for distinguishing the traveling lane.

Still another aspect of the present disclosure provides a control method of a control apparatus, the control method comprising: recognizing a state of a target in an external environment of a moving body; recognizing lines for distinguishing a traveling lane on a movement route on which the moving body travels; setting, on the movement route, a search area for calculating a risk that is an index value indicating a degree to which the moving body needs to avoid entry; calculating the risk in the search area; and determining an action of the moving body based on the calculated risk, wherein the setting sets the search area based on a first line closest to the moving body among the recognized lines for distinguishing the traveling lane.

Yet still another aspect of the present disclosure provides a non-transitory computer readable storage medium storing a program for causing a computer to function as each unit of a control apparatus, the control apparatus comprising: a target recognition unit configured to recognize a state of a target in an external environment of a moving body; a line recognition unit configured to recognize lines for distinguishing a traveling lane on a movement route on which the moving body travels; a setting unit configured to set, on the movement route, a search area for calculating a risk that is an index value indicating a degree to which the moving body needs to avoid entry; a calculation unit configured to calculate the risk in the search area; and a determination unit configured to determine an action of the moving body based on the calculated risk, wherein the setting unit sets the search area based on a first line closest to the moving body among the recognized lines for distinguishing the traveling lane.

According to the present invention, it is possible to appropriately assist driving even when some lines among the plurality of lines for distinguishing the traveling lane cannot be recognized.

### BRIEF DESCRIPTION OF THE DRAWINGS

FIG. 1 is a diagram illustrating a configuration example of a vehicle as an example of a moving body according to an embodiment;

FIG. 2 is a block diagram illustrating a functional configuration example of a control apparatus according to the embodiment;

FIG. 3A is a view for describing an example of a situation where a traveling lane recognition unit according to the embodiment has failed to recognize a traveling lane;

FIG. 3B is a view for describing driving assistance processing according to the embodiment;

FIG. 4 is a flowchart illustrating a series of operations of the driving assistance processing according to the embodiment;

FIG. 5 is a view for describing an example of a relationship between a speed range and a distance for setting a virtual line according to the embodiment; and

FIG. 6 is a view illustrating an example of a risk for a target according to the embodiment.

### DESCRIPTION OF THE EMBODIMENTS

### First Embodiment

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Configuration Example of Vehicle>

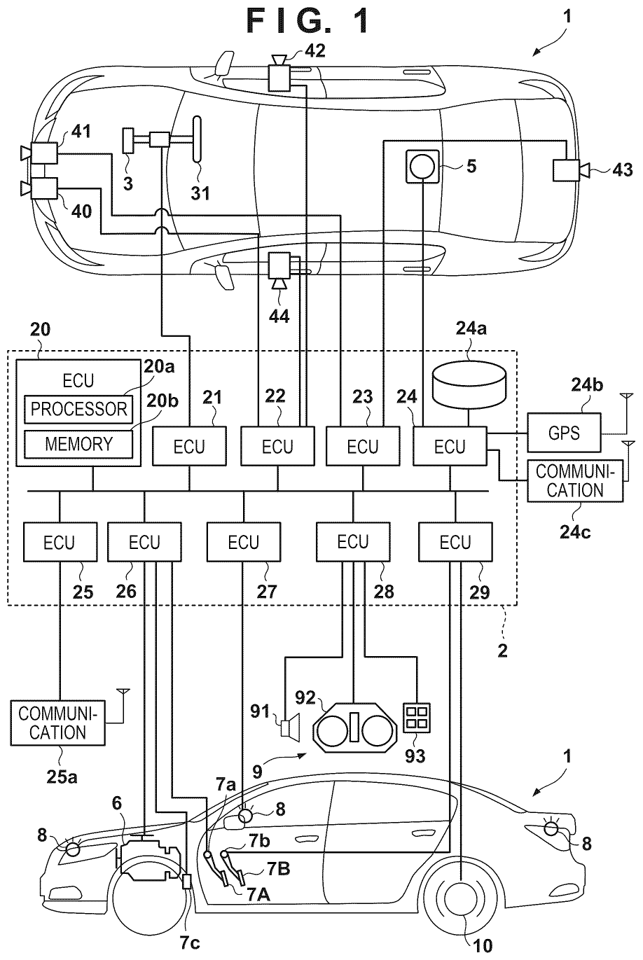

FIG. 1 is a block diagram of a vehicle 1 as an example of a moving body according to the present invention. In FIG. 1, an outline of the vehicle 1 is illustrated in a plan view and in a side view. The vehicle 1 is a four-wheeled passenger vehicle as an example, but may be a two-wheeled vehicle or another type of vehicle. In addition, the moving body according to the present invention is not limited to a vehicle, and may include various moving bodies such as a robot that autonomously travels.

The vehicle 1 includes a vehicle control apparatus (hereinafter, simply referred to as a control apparatus 2) that controls the vehicle 1. The control apparatus 2 includes a plurality of electronic control units (ECUs) 20 to 29 communicably connected by an in-vehicle network. Each of the ECUs includes a processor such as a central processing unit (CPU) or a graphics processing unit (GPU), a memory such as a semiconductor memory, an interface with an external device, and the like. The memory stores a program to be executed by the processor, data to be used for processing by the processor, and the like. Each of the ECUs may include a plurality of processors, memories, interfaces, and the like. For example, the ECU 20 includes a processor 20a and a memory 20b. Processing by the ECU 20 is performed by the processor 20a executing a command included in a program stored in the memory 20b. Instead of this, the ECU 20 may include a dedicated integrated circuit such as an application specific integrated circuit (ASIC) for performing the processing by the ECU 20. A similar configuration applies to the other ECUs.

Hereinafter, functions and the like assigned to the respective ECUs 20 to 29 will be described. Note that, the number of ECUs and functions to be performed can be designed as appropriate, and can be subdivided or integrated as compared with the present embodiment. For example, one ECU (for example, ECU 22) may have the function of another ECU.

The ECU 20 executes control related to manual traveling and automated traveling of the vehicle 1. In the automated traveling, at least one of steering and acceleration/deceleration of the vehicle 1 is automatically controlled. Note that, the automated traveling by the ECU 20 may include automated traveling (which may also be referred to as automated driving) that does not require a traveling operation by a driver and automated traveling (which may also be referred to as driving assistance) for assisting the traveling operation by the driver. The control of traveling by the ECU 20 may include, for example, control of automatically stopping or steering the vehicle in order to avoid collision instead of driving by the driver.

The ECU 21 controls an electric power steering device 3. The electric power steering device 3 includes a mechanism that steers front wheels in accordance with a driver's driving operation (steering operation) on a steering wheel 31. In addition, the electric power steering device 3 includes a motor that exerts a driving force for assisting the steering operation or automatically steering the front wheels, a sensor that detects a steering angle, and the like. When a driving state of the vehicle 1 is the automated driving, the ECU 21 automatically controls the electric power steering device 3 in response to an instruction from the ECU 20, and controls a traveling direction of the vehicle 1.

The ECUs 22 and 23 control detection units that detect a surrounding situation of the vehicle and performs information processing on detection results. The vehicle 1 includes, for example, one standard camera 40 and four fisheye cameras 41 to 44 as the detection units that detect the surrounding situation of the vehicle. The standard camera 40 and the fisheye cameras 42 and 44 are connected to the ECU 22. The fisheye cameras 41 and 43 are connected to the ECU 23. The ECUs 22 and 23 can recognize a state of a target such as the type, position, and speed of the target, a lane area on a movement route, and lines for distinguishing a traveling lane by analyzing images captured by the standard camera 40 and the fisheye cameras 41 to 44. The lines for distinguishing the traveling lane include a traveling road boundary (white line) and a dividing line (broken line or the like) between a lane and a lane. Note that, the types, number, and attachment positions of the cameras included in the vehicle 1 are not limited to the example of the present embodiment, and other configurations may be adopted. In addition, a light detection and ranging (LiDAR) or a millimeter wave radar as a detection unit for detecting a target around the vehicle 1 and measuring a distance to the target may be included.

The standard camera 40 is attached at the center in a front part of the vehicle 1, and captures an image of a surrounding situation ahead of the vehicle 1. The fisheye camera 41 is attached at the center in the front part of the vehicle 1, and captures an image of a surrounding situation ahead of the vehicle 1. In FIG. 1, the standard camera 40 and the fisheye camera 41 are illustrated to be aligned in a horizontal direction. However, the arrangement of the standard camera 40 and the fisheye camera 41 is not limited to this, and for example, these may be aligned in a vertical direction. In addition, at least one of the standard camera 40 and the fisheye camera 41 may be attached at a front part of a roof of the vehicle 1 (for example, on a vehicle interior side of a windshield). The fisheye camera 42 is attached at the center in a right side part of the vehicle 1, and captures an image of a surrounding situation on a right side of the vehicle 1. The fisheye camera 43 is attached at the center in a rear part of the vehicle 1, and captures an image of a surrounding situation behind the vehicle 1. The fisheye camera 44 is attached at the center in a left side part of the vehicle 1, and captures an image of a surrounding situation on a left side of the vehicle 1.

The ECU 22 controls the standard camera 40 and the fisheye cameras 42 and 44 and performs information processing on detection results. The ECU 23 controls the fisheye cameras 41 and 43 and performs information processing on detection results. The reliability of the detection results can be improved by dividing the detection units that respectively detect the surrounding situation of the vehicle into two systems. In addition, the ECU 22 can detect a direction of a head and a line of sight of the driver using an image obtained by capturing the driver with a fisheye camera (not illustrated) installed in the vehicle interior.

The ECU 24 controls a gyro sensor 5, a GPS sensor 24b, and a communication device 24c, and performs information processing on detection results or a communication result. The gyro sensor 5 detects a rotational movement of the vehicle 1. A course of the vehicle 1 can be determined based on a detection result of the gyro sensor 5, a wheel speed, and the like. The GPS sensor 24b detects a current position of the vehicle 1. The communication device 24c performs wireless communication with a server that provides map information and traffic information, and acquires pieces of these information. The ECU 24 can access a map information database 24a constructed in a memory, and the ECU 24 performs searching for a route from a current location to a destination and the like. The ECU 24, the map information database 24a, and the GPS sensor 24b constitute a so-called navigation device.

The ECU 25 includes a communication device 25a for vehicle-to-vehicle communication. The communication device 25a performs, for example, wireless communication with other surrounding vehicles to exchange information between the vehicles.

The ECU 26 controls a power plant 6. The power plant 6 is a mechanism that outputs a driving force for rotating driving wheels of the vehicle 1, and includes, for example, an engine and a transmission. For example, the ECU 26 controls an output of the engine in response to a driving operation (accelerator operation or acceleration operation) of the driver that has been detected by an operation detection sensor 7a provided on an accelerator pedal 7A, or switches a gear ratio of the transmission based on information such as a vehicle speed detected by a vehicle speed sensor 7c or the like.

The ECU 27 controls lighting devices (headlights, taillights, and the like) including direction indicators 8 (winkers). In the example of FIG. 1, the direction indicators 8 are respectively provided at the front part, door mirrors, and the rear part of the vehicle 1.

The ECU 28 controls an input/output device 9. The input/output device 9 outputs information to a passenger (for example, driver) and receives an input of information from the driver. A voice output device 91 notifies the driver of information by, for example, a voice including a predetermined sound or utterance. The notification content is output, for example, when the ECU 22 performs driving assistance processing to be described later, determines execution of notification, and transmits the notification content to the ECU 28. The driving assistance processing will be described later. A display device 92 notifies the driver of information by displaying an image. The display device 92 is arranged, for example, in front of a driver's seat, and constitutes an instrument panel or the like. Note that, although the voice and the display have been given as examples here, information may also be notified by vibration or light. In addition, information may be notified by a combination of two or more of the voice, the display, the vibration, and the light. An input device 93 is a group of switches that are arranged at positions for the driver to be able to operate and give an instruction to the vehicle 1, but may also include a voice input device.

The ECU 29 controls a brake device 10 and a parking brake (not illustrated). The brake device 10 is, for example, a disc brake device, and is provided on each wheel of the vehicle 1 to decelerate or stop the vehicle 1 by applying resistance to the rotation of the wheel. The ECU 29 controls the activation of the brake device 10 in response to a driver's driving operation (braking operation) that has been detected by an operation detection sensor 7b, which is provided on a brake pedal 7B, for example. When the driving state of the vehicle 1 is the automated driving, the ECU 29 automatically controls the brake device 10 in response to an instruction from the ECU 20 to control the vehicle 1 to be decelerated and stopped. The brake device 10 and the parking brake can also be activated to keep the vehicle 1 in the stopped state. In addition, in a case where the transmission of the power plant 6 includes a parking lock mechanism, it is also possible to activate the parking lock mechanism to keep the vehicle 1 in the stopped state.

### <Functional Configuration Example Implemented in ECU 22>

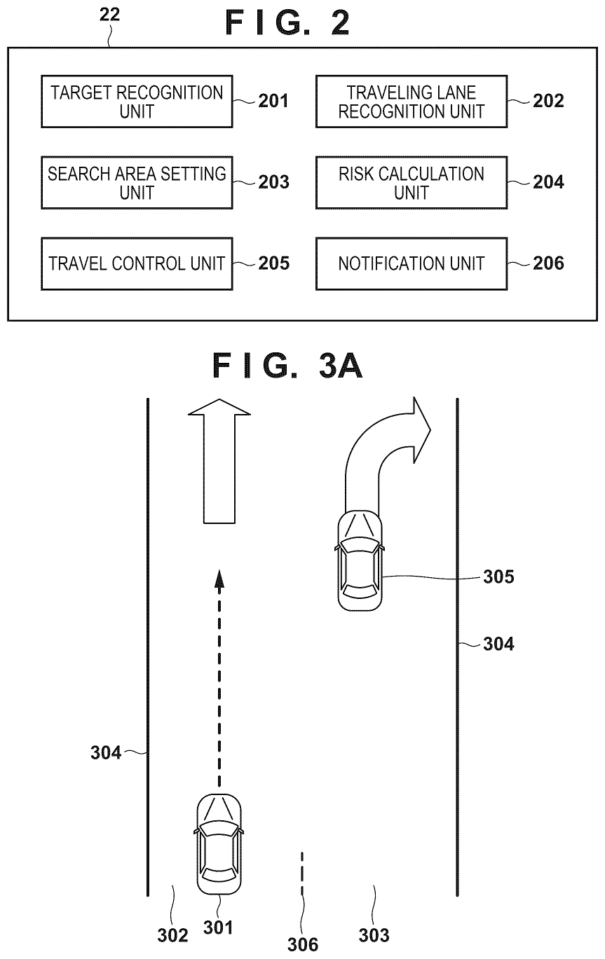

Next, a functional configuration example implemented in the ECU 22 will be described with reference to FIG. 2. Note that some or all of functions described below as the functions implemented in the ECU 22 may be implemented in another ECU (for example, the ECU 20). The functional configuration example illustrated in FIG. 2 illustrates an example of a functional configuration implemented by the ECU 22 executing a program stored in an internal memory. In addition, the functional configuration example illustrated in FIG. 2 focuses on a configuration related to the driving assistance processing to be described later. Therefore, the functions implemented in the ECU 22 are not limited to those illustrated in FIG. 2 and may include other functions.

A target recognition unit 201 recognizes a state of a target in an external environment of the vehicle 1 based on at least one of an image obtained from the detection unit and sensor information of the LiDAR or the like. The target includes, for example, a moving body (a peripheral vehicle, a passerby such as a pedestrian or a person riding a bicycle) around the vehicle 1 or a falling object. The state of the target includes, for example, a type of the target, a position of the target, a speed of the target, a movement trajectory of the target, and the like. The position of the target may be a relative position from the vehicle 1. The target recognition unit 201 can recognize the state of the target in the external environment using, for example, one or more neural networks, but may use another learning model.

A traveling lane recognition unit 202 recognizes a traveling lane on the movement route on which the vehicle 1 travels based on at least one of the image obtained from the detection unit and the sensor information of the LiDAR or the like. Information of the recognized traveling lane includes, for example, information of a traveling road boundary, a dividing line, and a lane area on the movement route. The traveling lane recognition unit 202 can recognize the traveling lane on the movement route by, for example, one or more neural networks, but may use another learning model. Note that, the function of the target recognition unit 201 and the function of the traveling lane recognition unit 202 may be implemented by one neural network or learning model.

The traveling lane recognition unit 202 recognizes two traveling road boundaries or dividing lines, and determines that the recognition of the traveling lane is successful in a case where a distance therebetween is equal to or less than a predetermined distance (for example, 5 meters). On the other hand, the traveling lane recognition unit 202 determines that the recognition of the traveling lane has failed in a case where only one traveling road boundary or dividing line is recognized and in a case where two traveling road boundaries or dividing lines are recognized, but a distance therebetween is farther than the predetermined distance (for example, 5 meters).

A search area setting unit 203 sets, on the traveling lane, a search area for calculating a risk that is an index value indicating a degree to which the vehicle needs to avoid entry. A risk for a specific target becomes a negative value (the degree to which entry needs to be avoided increases) as a distance to the recognized target is closer, and decreases to reach zero the distance to the target is farther. The search area includes, for example, a first observation point set on the traveling direction side of the self-vehicle and one or more second observation points (two in an example to be described later) in each of left and right directions with respect to the first observation point as viewed from the self-vehicle. These observation points are grouped to calculate risks at the respective observation points in the search area, and the lowest risk among the calculated risks, whereby a travel trajectory with the lowest risk can be obtained. Note that a case where one observation point is set at a predetermined position from the self-vehicle on the traveling direction side is illustrated in the present embodiment, but a plurality of observation points can be arranged on the traveling direction side, and a plurality of observation points can be set in each of left and right directions with respect to each of the observation points. In this manner, it is possible to grasp a risk existing in a specific direction or position on the traveling lane. Note that calculating a risk at each observation point in the search area is also simply referred to as calculating a risk in the search area in the following description.

In a case where at least one traveling road boundary or dividing line (hereinafter, traveling road boundary is simply taken as an example) is recognized, but recognition of the traveling lane fails, the search area setting unit 203 sets a virtual dividing line at a position separated by a predetermined distance from the traveling lane boundary closest to the vehicle. The virtual dividing line is a line for virtually distinguishing the traveling lane. In this manner, the search area setting unit 203 can set the virtual traveling lane. Then, the search area setting unit 203 sets a search area in a range from the closest traveling road boundary to the virtual dividing line. In this manner, even in a case where the recognition of the lane has failed, it is possible to set the virtual traveling lane using the recognized traveling road boundary or the like and set the search area in an appropriate range.

A risk calculation unit 204 calculates a risk in the set search area. Furthermore, the risk calculation unit 204 sets a risk potential. The risk potential may be set using a known technique. The risk potential may be a combination of a risk potential set for the traveling lane and a risk potential caused by the presence of a target, but only the risk potential caused by the presence of the target may be used.

FIG. 6 schematically illustrates an example of the risk potential caused by the presence of a target (for example, a vehicle 605). The vertical axis indicates a risk level, and the horizontal axis indicates a position of the vehicle 605 in the left-and-right direction. In a range 602 proximate to the vehicle 605, the risk potential indicates the highest value of the risk set for the vehicle 605. In a range 601 and a range 603, the risk decreases as a distance from the center of the vehicle 605 increases. A similar risk potential may be set ahead of and behind the vehicle 605. The risk potential set for the target is also referred to as a target potential or the like. In a case where a search area for calculating a risk is present in the ranges 601 to 603, the risk increases due to the presence of the vehicle 605. On the other hand, in a case where the search area does not overlap the ranges 601 to 603, the risk does not increase due to the presence of the vehicle 605.

The risk potential set for the traveling lane is set such that, for example, a risk value is the lowest at the center of the traveling lane and increases as a distance from the center increases (as a distance to the traveling road boundary decreases). Such a risk potential is also referred to as an induced potential or the like. When such a risk potential is used, the risk is the lowest near the center of the traveling lane in the search area. In addition, the risk increases near a traveling road boundary in the search area.

A travel control unit 205 determines an action of the vehicle based on a risk calculated in a search area. For example, the travel control unit 205 controls automated traveling so as to travel at a position of the observation point at which the lowest risk is calculated. The automated traveling may include automated traveling of the vehicle not requiring a traveling operation by the driver, or automated traveling for assisting the traveling operation by the driver.

A notification unit 206 notifies the driver based on a risk calculated in a search area. In a case where the risk (at any observation point) in the search area exceeds a predetermined value, the notification unit 206 notifies the driver of a predetermined warning sound or a voice using a natural language (including an expression representing a recognized target).

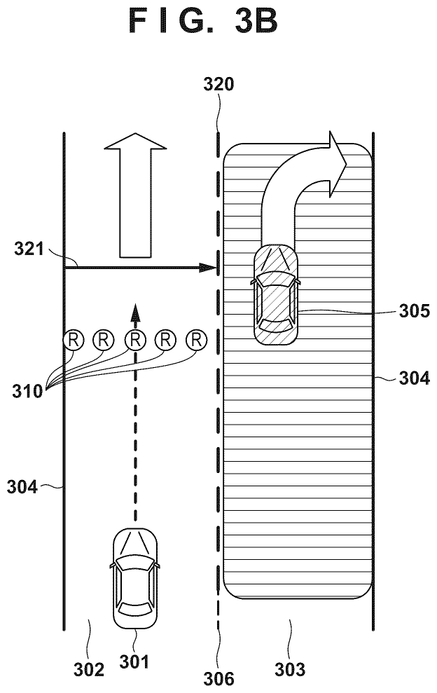

Next, an example of the driving assistance processing according to the present embodiment will be described with reference to FIGS. 3A and 3B. FIG. 3A illustrates an example of a situation in which the traveling lane recognition unit 202 fails to recognize the traveling lane. In the example illustrated in FIG. 3A, a vehicle 301 (that is, the vehicle 1) which is the self-vehicle is traveling in a traveling lane 302 on a movement route. A road on which the vehicle 301 travels includes a plurality of traveling lanes including the traveling lane 302 and a traveling lane 303. However, a dividing line 306 between the traveling lane 302 and the traveling lane 303 is faded, and thus is not visually clear. On the other hand, a traveling road boundary 304 of each of the traveling lane 302 and the traveling lane 303 is visually clear.

The vehicle 301 travels straight in the traveling lane 302 where straight traveling is possible. On the other hand, a vehicle 305 is stopped (to turn right), for example, in the traveling lane 303 which is a traveling lane dedicated to the right turn.

When the vehicle 301 travels in the traveling lane 302, the target recognition unit 201 recognizes a state of a target including a position, a speed, a movement trajectory, and the like of the vehicle 305. In addition, the traveling lane recognition unit 202 recognizes a traveling road boundary, a dividing line, and a lane region of the traveling lane 302.

In the example illustrated in FIG. 3A, it is assumed that the traveling lane recognition unit 202 cannot recognize the dividing line 306 but can recognize the traveling road boundaries 304. In this case, the traveling lane recognition unit 202 has recognized two traveling road boundaries, but determines that the recognition of the traveling lane has failed since a distance therebetween is farther than the predetermined distance.

In a case where the recognition of the traveling lane has failed, the traveling lane recognition unit 202 sets a virtual line (for example, the dividing line 320) for virtually distinguishing the traveling lane at a position separated by a predetermined distance 321 from the traveling road boundary 304 closest to the vehicle 301 as illustrated in FIG. 3B. Then, the search area setting unit 203 sets a search area in a range of the predetermined distance from the traveling road boundary 304.

In the example of FIG. 3B, observation points 310 in the search area are set at predetermined distances from the vehicle 301. Although one search area including one set of observation points is illustrated in the example of FIG. 3B, a plurality of search areas can be set in the virtual traveling lane. The risk calculation unit 204 combines risks of risk potentials at the observation points 310 in the search area to calculate a risk in the search area. At this time, the risk calculation unit 204 may exclude a target (for example, the vehicle 305) located outside a range of the virtual traveling lane from the calculation of the risk.

In this manner, the vehicle 301 can determine an action of the vehicle such as automated traveling or notification to the driver based on the risk calculated in the search area. It is possible to mitigate the influence of the vehicle 305 originally present in a different traveling lane, and it is possible to appropriately assist driving even in a case where some lines among a plurality of lines for distinguishing the traveling lane cannot be recognized.

Note that the above-described risk may correspond to a possibility of collision between the vehicle 301 and another target (the vehicle 305). At this time, the travel control unit 205 or the notification unit 206 determines an action of the vehicle based on a possibility of collision between vehicle 301 and the other target (the vehicle 305).

### <Series of Operations of Driving Assistance Processing in Vehicle>

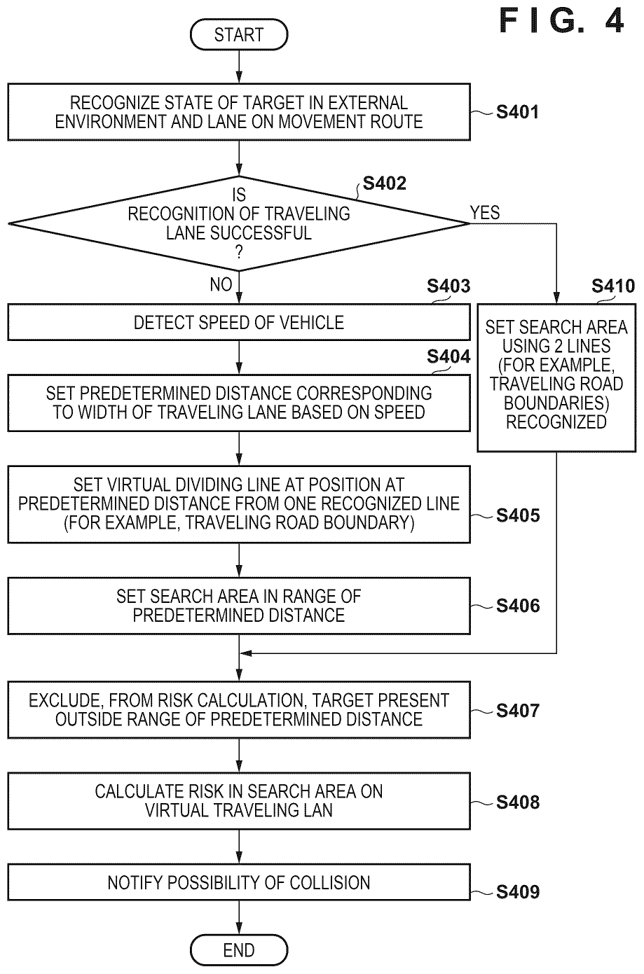

Next, a series of operations of the driving assistance processing in the vehicle will be described with reference to FIG. 4. This processing is implemented, for example, by the processor 20a of the ECU 22 of the control apparatus 2 executing the program in the memory 20b.

In S401, the target recognition unit 201 recognizes a state of a target in an external environment of the vehicle 1 based on at least one of an image obtained from the detection unit and sensor information of the LiDAR or the like. In addition, the traveling lane recognition unit 202 recognizes a traveling lane on a movement route on which the vehicle 1 travels based on at least one of the image obtained from the detection unit and the sensor information of the LiDAR or the like.

In S402, the traveling lane recognition unit 202 determines whether the recognition of the traveling lane is successful. The traveling lane recognition unit 202 advances the processing to S410 in a case where it is determined that the recognition of the traveling lane is successful based on the above-described criteria, and advances the processing to S403 in a case where it is determined that the recognition of the traveling lane has failed. This processing may be ended in a case where the traveling lane recognition unit 202 has not recognized any traveling road boundary or dividing line.

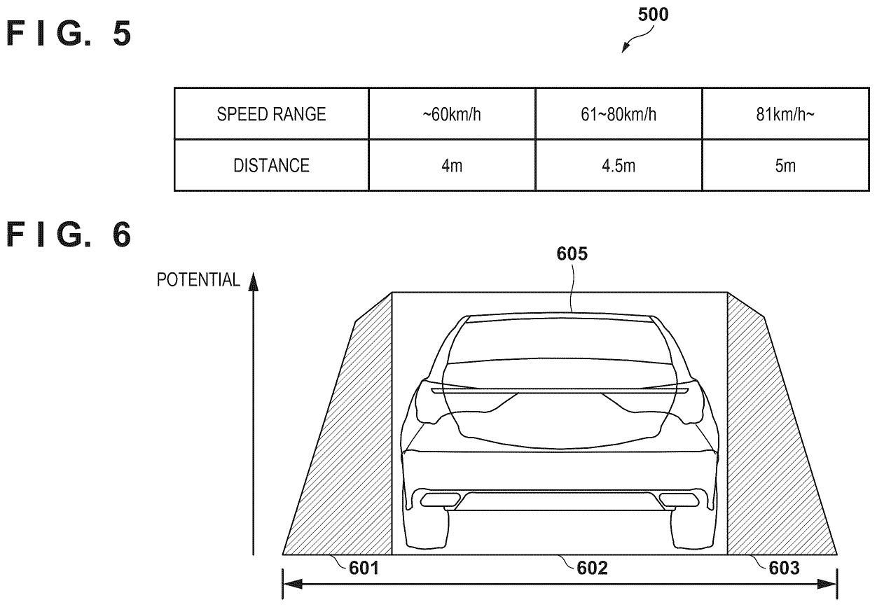

In S403, the ECU 22 detects a moving speed of the vehicle 1 based on, for example, a detection result of the gyro sensor 5 or the like. In S404, the search area setting unit 203 sets a predetermined distance corresponding to a width of the traveling lane based on the speed. For example, the search area setting unit 203 sets the predetermined distance with reference to a table 500 as illustrated in FIG. 5. The table 500 is, for example, a table in which a speed range of the vehicle is associated with the predetermined distance corresponding to the width of the traveling lane, and is stored in a memory. In this manner, the search area setting unit 203 varies a width of a traveling lane set virtually depending on the speed of the vehicle 1. More specifically, the search area setting unit 203 increases the predetermined distance as the moving speed of the vehicle 1 increases. Then, a wider lane width can be set in a case where the vehicle travels on a road on which traveling at a high speed is possible. That is, the width of the virtual traveling lane can be made closer to the width of the actual traveling lane.

The search area setting unit 203 may set the predetermined distance using vehicle width information of a road included in map information. For example, the search area setting unit 203 can acquire the vehicle width information included in the map information by accessing the map information database 24a. Alternatively, the search area setting unit 203 may acquire the vehicle width information from an external server via the communication device 25a.

In S405, the search area setting unit 203 sets a virtual line (for example, a dividing line) at a position at the predetermined distance from one line (for example, a traveling road boundary) recognized by the traveling lane recognition unit 202 as described above. Then, in S406, the search area setting unit 203 sets a search area in a range (range of the predetermined distance) from the traveling road boundary to the virtual line as described above.

In S410, the search area setting unit 203 sets the search area between two lines (for example, traveling road boundaries) recognized by the traveling lane recognition unit 202 as described above.

In S407, the risk calculation unit 204 excludes, from risk calculation, a target present outside the range of the predetermined distance from the traveling road boundary as described above. Then, in S408, the risk calculation unit 204 calculates a risk in the search area set in the range of the predetermined distance from the traveling road boundary (that is, on the virtual traveling lane). As described above, the risk calculation unit 204 calculates the risk, for example, using a risk value of a risk potential in the search area on the virtual traveling lane to set a risk potential on the traveling lane.

In S409, when the calculated risk is equal to or more than a predetermined value, the risk calculation unit 204 causes the notification unit 206 to notify the driver. As described above, the notification unit 206 notifies the driver of a predetermined warning sound or a voice using a natural language (including an expression representing the recognized target). After the notification by the notification unit 206 ends, the series of operations of the driving assistance processing ends.

Although the case where the notification is performed when the calculated risk is equal to or more than the predetermined value has been described as an example in the series of operations of the driving assistance processing described above, either of the automated traveling by the travel control unit 205 may be performed in accordance with the calculated risk. In addition, both the notification by the notification unit 206 and the automated traveling by the travel control unit 205 may be performed.

As described above, in the above-described embodiment, the vehicle 1 recognizes a state of a target in an external environment and lines for distinguishing a traveling lane on a movement route on which the vehicle 1 travels. In addition, the vehicle 1 sets, on the movement route, a search area for calculating a risk that is an index value indicating a degree to which the vehicle 1 needs to avoid entry, and calculates the risk including the influence of the recognized target in the search area on the movement route, thereby determining an action of the vehicle based on the risk calculated in the search area. At this time, the vehicle 1 sets the search area in a range of a predetermined distance from a first line (for example, a traveling road boundary) closest to the vehicle 1 among the lines for distinguishing the recognized traveling lane. In this manner, it is possible to reduce the influence of the target originally present in a different traveling lane, and thus it is possible to appropriately assist driving even in a case where some lines among a plurality of lines for distinguishing the traveling lane cannot be recognized.

### Second Embodiment

In a second embodiment, an example in which another method is used for setting a search area will be described. Specifically, a search area can be set outside a range from the traveling road boundary 304 to a virtual line. For example, the search area setting unit 203 can set the search area between the recognized two traveling road boundaries 304. For example, instead of setting the search area in the range from the traveling road boundary to the virtual line (range of a predetermined distance) in S406 described above, the risk calculation unit 204 can set the search area in a range wider than the range of the predetermined distance from the traveling road boundary (that is, on a virtual traveling lane). Thereafter, the risk calculation unit 204 calculates risks in the set search area. In this case, the setting of the virtual line in S403 to S405 and the setting of the search area in S406 in the first embodiment may be performed before, in parallel with, or after the setting of the search area in S406.

When the search area and the virtual line are set, the travel control unit 205 or the notification unit 206 determines an action of a vehicle based on a risk calculated in the range from the traveling road boundary 304 to the virtual line among the risks calculated in the search area. That is, among the calculated risks, a risk calculated outside the range of the virtual traveling lane is not used, and thus, the risk is not subject to control or notification. Also with such an embodiment, it is possible to appropriately assist driving when some lines among a plurality of lines for distinguishing a traveling lane cannot be recognized.

### Third Embodiment

The case where the traveling lane recognition unit 202 according to the first embodiment recognizes two traveling road boundaries or dividing lines and determines that recognition of a traveling lane is successful when a distance therebetween is equal to or less than a predetermined distance has been described as an example. A method of recognizing the traveling lane is not limited thereto, and other methods can also be adopted.

For example, additional processing may be performed when only dividing lines are detected and any traveling road boundary is detected at all. Specifically, when only the dividing lines are detected and any traveling road boundary is not detected at all, the traveling lane recognition unit 202 may consider that a traveling road boundary is detected as a broken line, complement the broken line, and recognize the broken line as the traveling road boundary. For the complementation of the broken line, for example, lines are detected first for fragmentary line segments, respectively, in the broken line, and a plurality of the detected lines are integrated, whereby one broken line can be recognized as one line (traveling road boundary). As a result of such complementation processing, when a distance between two traveling road boundaries become equal to or less than a predetermined distance, it can be determined that the recognition of the traveling lane is successful (that is, it is not necessary to set a virtual traveling lane to be described later).

For example, in the determination of whether the recognition of the traveling lane is successful in S402 of the driving assistance processing described above, the traveling lane recognition unit 202 can determine that the recognition of the traveling lane is successful in a case where only two dividing lines are detected. In this case, it is further determined whether a distance between two traveling road boundaries is equal to or less than the predetermined distance. At this time, a negative determination is made since only the two dividing lines are detected. In such a case, when only the two dividing lines are detected, the traveling lane recognition unit 202 may complement a broken line to recognize the line as a traveling road boundary. The search area setting unit 203 can determine a search area based on the traveling road boundary obtained by the complementation. In this manner, even when only the dividing lines are recognized, it is possible to set the search area and perform subsequent processing such as risk calculation.

### Summary of Embodiment

### (Item 1)

A control apparatus comprising:
a target recognition unit (for example, 201) configured to recognize a state of a target in an external environment of a moving body;
a line recognition unit (for example, 202) configured to recognize lines for distinguishing a traveling lane on a movement route on which the moving body travels;
a setting unit (for example, 203) configured to set, on the movement route, a search area for calculating a risk that is an index value indicating a degree to which the moving body needs to avoid entry;
a calculation unit (for example, 204) configured to calculate the risk in the search area; and
a determination unit (for example, 205, 206) configured to determine an action of the moving body based on the calculated risk,
wherein the setting unit sets the search area based on a first line closest to the moving body among the recognized lines for distinguishing the traveling lane.

According to this embodiment, it is possible to appropriately assist driving even when some lines (for example, dividing lines) among a plurality of lines for distinguishing the traveling lane cannot be recognized.

### (Item 2)

The control apparatus according to item 1, wherein the setting unit sets the search area in a range of a predetermined distance from the first line (for example, 304).

According to this embodiment, the search area can be set in an appropriate range when some lines (for example, dividing lines) among the plurality of lines for distinguishing the traveling lane cannot be recognized.

### (Item 3)

The control apparatus according to item 1, wherein the calculation unit excludes, from the calculation of the risk, the recognized target (for example, 305) located outside a range of a predetermined distance from the first line.

According to this embodiment, it is possible to suppress a decrease in accuracy of driving assistance by the target located outside the traveling lane on which the moving body travels.

### (Item 4)

The control apparatus according to item 1, wherein the action of the moving body includes notification to a driver of the moving body.

According to this embodiment, it is possible to suppress a decrease in accuracy of notification based on the risk even when some lines (for example, dividing lines) among the plurality of lines for distinguishing the traveling lane cannot be recognized.

### (Item 5)

The control apparatus according to item 1, wherein the action of the moving body includes automated traveling of the moving body not requiring a traveling operation by a driver or automated traveling for assisting the traveling operation by the driver.

According to this embodiment, it is possible to suppress a decrease in accuracy of automated traveling based on the risk even when some lines (for example, dividing lines) among the plurality of lines for distinguishing the traveling lane cannot be recognized.

### (Item 6)

The control apparatus according to item 1, wherein
the risk corresponds to a possibility of collision between the moving body and the recognized target in the search area, and
the determination unit determines the action of the moving body based on the possibility of collision between the moving body and the recognized target.

According to this embodiment, it is possible to suppress a decrease in accuracy in calculation of the possibility of collision with the target.

### (Item 7)

The control apparatus according to item 2, further comprising a speed detection unit (for example, 5) configured to detect a speed of the moving body,
wherein the setting unit varies the predetermined distance depending on the speed of the moving body.

According to this embodiment, a width of a virtual traveling lane can be made closer to a width of an actual traveling lane.

### (Item 8)

The control apparatus according to item 7, wherein the setting unit increases the predetermined distance as the speed of the moving body increases.

According to this embodiment, a wider lane width can be set when the moving body travels on a road on which traveling at a high speed is possible.

### (Item 9)

The control apparatus according to item 2, wherein the setting unit sets the predetermined distance using vehicle width information of a road included in map information (for example, 24a).

According to this embodiment, it is possible to set a preset highly accurate vehicle.

### (Item 10)

The control apparatus according to item 1, wherein the lines for distinguishing the traveling lane (for example, 304) are traveling road boundaries on the movement route.

According to this embodiment, it is possible to appropriately assist driving even when no dividing line can be recognized.

The invention is not limited to the foregoing embodiments, and various variations/changes are possible within the spirit of the invention.

What is claimed is:

1. A control apparatus comprising:
one or more processors; and
a memory storing instructions which, when the instructions are executed by the one or more processors, cause the control apparatus to function as:
a target recognition unit configured to recognize a state of a target in an external environment of a moving body;
a line recognition unit configured to recognize lines for distinguishing a traveling lane on a movement route on which the moving body travels;
a setting unit configured to set, on the movement route, a search area for calculating a risk that is an index value indicating a degree to which the moving body needs to avoid entry;
a calculation unit configured to calculate the risk in the search area; and
a determination unit configured to determine an action of the moving body based on the calculated risk,
wherein the setting unit sets the search area based on a first line closest to the moving body among the recognized lines for distinguishing the traveling lane.

2. The control apparatus according to claim 1, wherein the setting unit sets the search area in a range of a predetermined distance from the first line.

3. The control apparatus according to claim 1, wherein the calculation unit excludes, from the calculation of the risk, the recognized target located outside a range of a predetermined distance from the first line.

4. The control apparatus according to claim 1, wherein the action of the moving body includes notification to a driver of the moving body.

5. The control apparatus according to claim 1, wherein the action of the moving body includes automated traveling of the moving body not requiring a traveling operation by a driver or automated traveling for assisting the traveling operation by the driver.

6. The control apparatus according to claim 1, wherein
the risk corresponds to a possibility of collision between the moving body and the recognized target in the search area, and
the determination unit determines the action of the moving body based on the possibility of collision between the moving body and the recognized target.

7. The control apparatus according to claim 2, instructions further cause the control apparatus to function as a speed detection unit configured to detect a speed of the moving body,
wherein the setting unit varies the predetermined distance depending on the speed of the moving body.

8. The control apparatus according to claim 7, wherein the setting unit increases the predetermined distance as the speed of the moving body increases.

9. The control apparatus according to claim 2, wherein the setting unit sets the predetermined distance using vehicle width information of a road included in map information.

10. The control apparatus according to claim 1, wherein the lines for distinguishing the traveling lane are traveling road boundaries on the movement route.

11. A control method of a control apparatus, the control method comprising:
recognizing a state of a target in an external environment of a moving body;
recognizing lines for distinguishing a traveling lane on a movement route on which the moving body travels;
setting, on the movement route, a search area for calculating a risk that is an index value indicating a degree to which the moving body needs to avoid entry;
calculating the risk in the search area; and
determining an action of the moving body based on the calculated risk,
wherein the setting sets the search area based on a first line closest to the moving body among the recognized lines for distinguishing the traveling lane.

12. The control apparatus according to claim 1,
wherein the determination unit determines the action of the moving body based on the risk calculated within a range of a predetermined distance from a first line, closest to the moving body among the recognized lines for distinguishing the traveling lane, among a plurality of the risks calculated in the set search area.

13. The control apparatus according to claim 12, wherein the determination unit does not use a risk calculated within the search area but outside the range of the predetermined distance from the first line among the recognized lines for distinguishing the traveling lane.

14. The control method according to claim 11,
wherein in the determining, the action of the moving body is determined based on the risk calculated within a range of a predetermined distance from a first line, closest to the moving body among the recognized lines for distinguishing the traveling lane, among a plurality of the risks calculated in the set search area.

15. A non-transitory computer readable storage medium storing a program for causing a computer to function as each unit of a control apparatus, the control apparatus comprising:
a target recognition unit configured to recognize a state of a target in an external environment of a moving body;
a line recognition unit configured to recognize lines for distinguishing a traveling lane on a movement route on which the moving body travels;
a setting unit configured to set, on the movement route, a search area for calculating a risk that is an index value indicating a degree to which the moving body needs to avoid entry;
a calculation unit configured to calculate the risk in the search area; and
a determination unit configured to determine an action of the moving body based on the calculated risk,
wherein the setting unit sets the search area based on a first line closest to the moving body among the recognized lines for distinguishing the traveling lane.
